(19) United States
(12) Patent Application Publication
(10) Pub. No.: US 2025/0042187 A1
(43) Pub. Date: Feb. 6, 2025

(54) PRINTER FOR GENERATING TAGS USING ADJUSTABLE TAG SLOTS

(71) Applicant: Bruce Walter, Fort Mill, SC (US)

(72) Inventor: Bruce Walter, Fort Mill, SC (US)

(21) Appl. No.: 18/788,556

(22) Filed: Jul. 30, 2024

Related U.S. Application Data
(60) Provisional application No. 63/516,741, filed on Jul. 31, 2023.

(51) Int. Cl. B41J 13/12; B41J 2/325; B41J 3/407

(52) U.S. Cl. CPC B41J 13/12; B41J 2/325; B41J 3/407

(57) ABSTRACT

A printer for printing an associated clothing tag includes a printer main body; and at least one guide disposed on the printer main body, the at least one guide configured to position the associated clothing tag on a portion of the printer main body. In some embodiments, the printer also includes a touchscreen for receiving input information.

### CROSS-REFERENCE TO RELATED APPLICATIONS

This application claims the benefit of U.S. Provisional Application No. 63/516,741, filed Jul. 31, 2023, and is hereby incorporated by reference in its entirety for all purposes.

### FIELD OF THE INVENTION

The subject matter disclosed herein generally relates to a printer and more specifically to a printer for printing clothing tags.

### BACKGROUND

Garments, such as suits, dresses, sweaters, bathing suits, and so forth, are needed for different seasons of the year. Stores often do not sell out of these items during the seasons for which they are needed. For example, bathing suits are typically sold and worn during the summer season. When it is summer in the Northern hemisphere, for example, it is winter in the Southern hemisphere, where bathing suits are not being sold and worn. When the seasons change, the unsold inventory from a Northern hemisphere company can be sold to a Southern hemisphere country.

However, different countries have different methods for sizing and handling a garment. In the example scenario, a company from one country in the Northern hemisphere that sells bathing suits (for example, the United States, which uses the Customary Measurement System and the primary language is English) wants to sell their unsold inventory to a company in another country in the Southern hemisphere (for example, Brazil, which uses the metric system and the primary language is Portuguese). There may be confusion for the Brazilian worker over pricing due to different currencies, the size of the garment due to the different measurement systems, or handling of the garment may be unclear due to the language barrier.

The following discloses certain improvements to overcome these problems and others.

### SUMMARY OF THE INVENTION

The following is a concise summary of the invention presented herein with the primary aim of providing a preliminary understanding of certain aspects of the invention. It should be noted, however, that this summary is not intended to serve as a comprehensive overview of the invention, nor does it seek to identify or describe any critical or significant elements of the invention or the boundaries of its scope. Its sole purpose is to provide a rudimentary understanding of the invention's concepts and features, which will be expounded upon in greater detail in the ensuing sections.

The present disclosure is generally directed towards a printer for printing clothing tags (for example, clothing price tags) into an adjustable slot, and print variable information (such as prices, text, symbols, barcodes, logos, multi-lingual) directly onto the clothing tags using an adjustable position thermal transfer printer, which can be triggered by a hands-free, integrated foot pedal.

In some embodiments, a printer for printing an associated clothing tag includes a printer main body; and at least one guide disposed on the printer main body. The at least one guide is configured to position the associated clothing tag on a portion of the printer main body.

In some embodiments, a printer for printing an associated clothing tag includes a printer main body; and two guides disposed on the printer main body. The guides are configured to position the associated clothing tag on a portion of the printer main body.

In some embodiments, a printer for printing an associated clothing tag includes a printer main body; an ink ribbon; at least one guide disposed on the printer main body, the at least one guide configured to position the associated clothing tag on a portion of the printer main body; and a touchscreen attached to a portion of the printer main body. The touchscreen is configured to receive at least one user input indicative of information to be printed on the associated clothing tag; and control the ink ribbon to print the information to be printed on the clothing tag onto the clothing tag.

Advantageously, the disclosed printer enables a user slide fastened or unfastened clothing price tags into an adjustable slot, and print variable information (i.e., prices, text, symbols, barcodes, logos, languages) directly onto tags using an adjustable guide and an integrated foot pedal.

Advantageously, the disclosed printer includes a touchscreen controller onto which design templates are loaded (or sent via the Internet). Proprietary template design software can be included with the printer, which can interface with a broad variety of existing third-party software, databases and mainframes.

Advantageously, the disclosed printer provides for instantaneous loading of different templates/information for immediate printing of information onto a clothing tag, an ability to integrate with barcode scanners pulling data into template fields from independent databases, printing an unlimited number of common templates or different templates with each cycle, and a mounting assembly construction enables user to easily adjust printer position along both multiple axes, an adjustable tag slot width and position, an adjustable platform height, and axis rulers are inlaid for recording/repeating tag placements, and a compact design and integration of components requires a surface area of roughly one square foot only.

The above features and advantages will become apparent from the following detailed description taken with the accompanying drawings.

### BRIEF DESCRIPTION OF DRAWINGS

FIG. 1 is a front perspective view of a non-limiting exemplary embodiment of a printer.

FIG. 2 is another front perspective view of a non-limiting exemplary embodiment of the printer of FIG. 1.

FIG. 3 shows a zoomed portion of the printer of FIG. 2.

FIG. 4 shows an example of a clothing tag printed by the printer of FIG. 2.

### DETAILED DESCRIPTION OF THE INVENTION

The following detailed description and accompanying drawings provide a comprehensive disclosure of an exemplary embodiment for the purpose of facilitating one of ordinary skill in the relevant art to make and use the invention. As such, the detailed description and illustration of the one or more exemplary embodiments presented herein are purely exemplary in nature and are not intended to limit the scope of the invention or its protection in any matter. It is further noted that the drawings may not be to scale, and in some cases, certain details may be omitted which are not necessary for an understanding of the present invention, such as conventional details of fabrication and assembly. Furthermore, there is no intention to be bound by any expressed or implied theory presented in the preceding technical field, background, brief summary or the following detailed description.

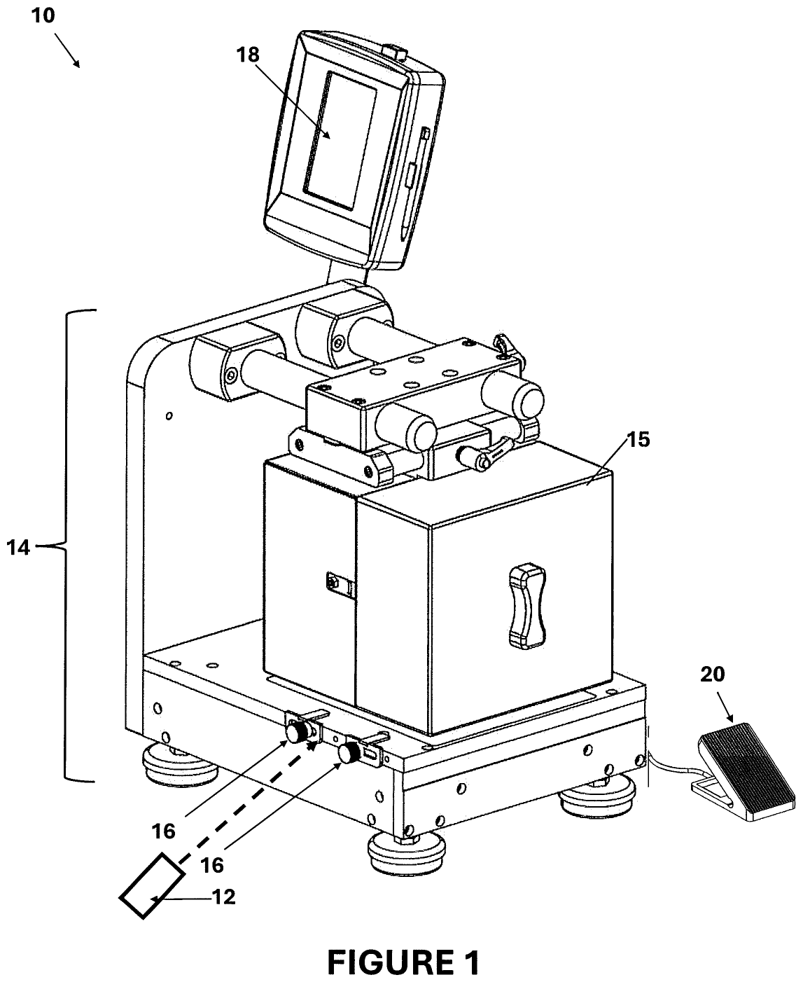

For purposes of description herein, the terms “upper”, “lower”, “left”, “rear”, “right”, “front”, “vertical”, “top”, “bottom”, “side” and derivatives thereof shall relate to the device as oriented in FIG. 1. Furthermore, there is no intention to be bound by any expressed or implied theory presented in the preceding technical field, background, brief summary or the following detailed description.

FIG. 1 shows a non-limiting, exemplary embodiment (herein after as the “exemplary embodiment”) of a printer 10 is disclosed herein. The printer 10 is configured to print information on a clothing tag 12. The printer 10 can be any suitable clothing tag printer (e.g., a FlexPack PRO 130 Thermal Transfer Overprinter available from FlexPackPro®, Fort Mill, SC 29707, USA). With brief reference to FIG. 1, the printer 10 includes a printer main body 14 that includes a cover 15, at least one guide 16 disposed on the printer main body 14, a touchscreen 18, and a foot pedal 20.

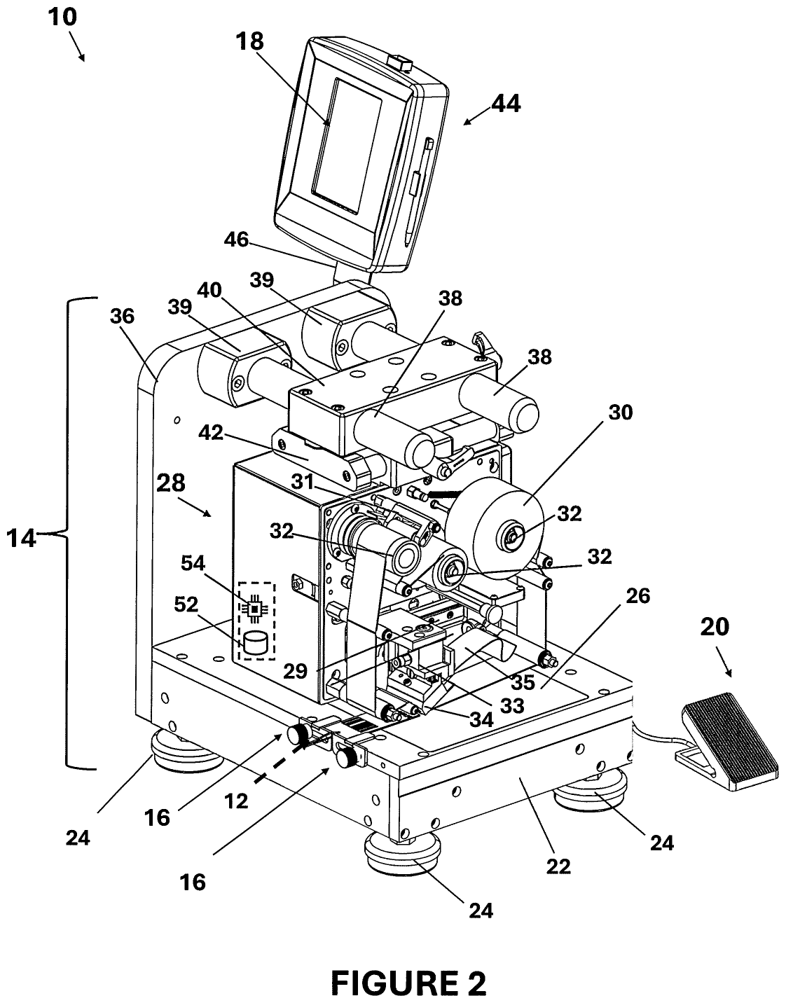

FIG. 2 shows the printer 10, but with the cover 15 of the printer main body 14 removed so that internal components of the printer 10 (described in more detail below) are visible. As shown in FIG. 2, the printer main body 14 includes a base 22 with one or more feet 24 (three of which are shown in FIG. 2 with a fourth hidden from view in the unshown corner of the printer 10 in FIG. 2). The feet 24 are positioned on a bottom surface of the base 22, and can be adjusted to change a height of the printer 10.

A top surface of the base 22 comprises a print base 26, upon which an adjustable print head cartridge 28 is mounted. The print base 26 can be made, for example, from rubber. The print head cartridge 28 includes an ink ribbon 30 (i.e., a 35 mm wide near-edge thermal transfer ribbon). The ink ribbon 30 is mounted on one or more ink ribbon mounts 32 (three of which are shown in FIG. 2; although any suitable number of ink ribbon mounts can be used). A ribbon tensioner roller 31 is configured to take up slack in the ink ribbon 30 while mounted on the ribbon mounts 32. A print cartridge 29 (i.e., a horizontal thermal printhead cartridge) includes ink that is disposed on the ink ribbon 30 for printing onto the clothing tag 12.

An end of the ink ribbon 30 is fed through a printhead 34 (i.e., a 300 dpi 32 mm Near Edge Thermal Printhead) for printing information onto the clothing tag 12. The printhead 34 is connected to a pneumatic assembly 33 for engaging and is engaging the printhead 34 from the clothing tag 12. A thermal printhead cable 33 is configured to ink from the ink ribbon 30 onto the clothing tag 12.

A vertical mounting plate 36 is positioned at, and connected to, a portion of the base 22. The view in FIG. 2 shows the vertical mounting plate 36 at a “left” side of the base 22; however, the vertical mounting plate 36 can be positioned at any suitable position on the base 22. A bottom portion of the vertical mounting plate 36 can be attached to the base 22. One or more guide arms 38 are attached to a top portion of the vertical mounting plate 36. FIG. 2 shows two guide arms 38; however, any suitable number of guide arm mounts 38 can be used. Each guide arm 38 is secured to the vertical mounting plate 36 with a corresponding guide arm mount 39. Each guide arm 38 is positioned along a y-axis of the main printer body 14.

Each guide arm 38 can be fitted through an adjustable printer mounting assembly 40. The adjustable printer mounting assembly 40 can include one or more adjustable locking handles 42. A bottom portion of the adjustable printer mounting assembly 40 is attached to a top portion of the adjustable print head cartridge 28, and locked to each other with the adjustable locking handles 42. The adjustable print head cartridge 28 can also be detached from the adjustable printer mounting assembly 40 via the adjustable locking handles 42 to replace the adjustable print head cartridge.

An adjustable monitor 44 (i.e., an input/control device graphical user interface (GUI)) is attached to the top portion of the vertical mounting plate 36. The adjustable monitor 44 includes the touchscreen 18. The adjustable monitor 44 can also include a swivel 46 allowing a user to adjust a position of the touchscreen 18. In other embodiments (not shown in FIG. 2), the touchscreen 18 can comprise a mobile device (e.g., a tablet, an iPad, a smartphone, and so forth) in electronic communication with the printer 10 (i.e., via Bluetooth).

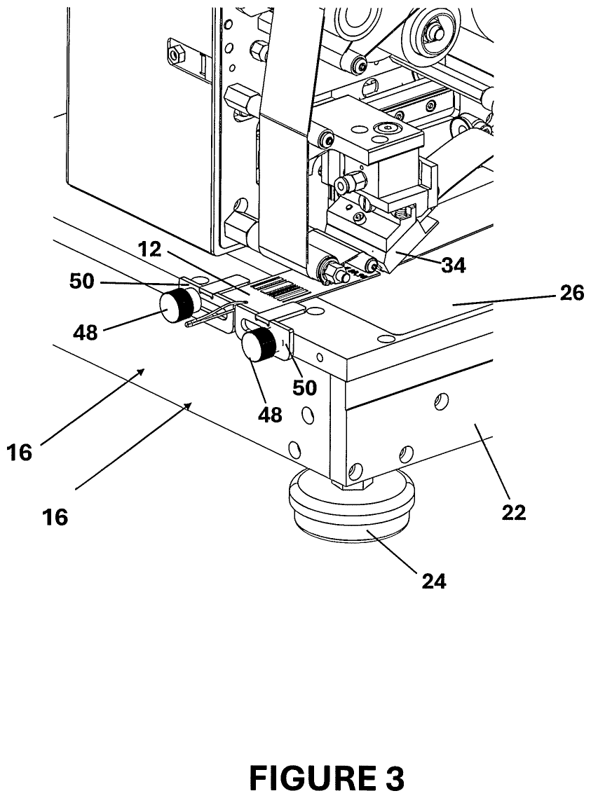

With continuing reference to FIG. 2, and now referring to FIG. 3, the at least one guide 16 is shown in more detail. As shown in FIG. 3, two guides 16 are shown; however, any suitable number of guides 16 can be used. The guides 16 are positioned along an x-axis of the main printer body 14 (i.e., the guides 16 are perpendicular to the guide arm mounts 38). The guide(s) 16 are configured to position the clothing tag 12 on a portion of the printer main body 14 (i.e., on the print base 26). Each guide 16 includes an adjustable knob 48, and a positioning plate 50 attached to the adjustable knob 48 and the printer main body 14 (i.e., on a portion of the base 22). Upon rotation of the adjustable knob 18, the positioning plate 50 is configured to move laterally along a portion of the base 22. The positioning plate(s) 50 are movable to create or define a space large enough for the clothing tab to fit on the print base 26. In one example embodiment, a user can manually (i.e., with his/her hand) rotate the adjustable knob(s) 48 to move the corresponding positioning plates 50 to generate the space for the clothing tag 12. In another example embodiment, the foot pedal 20 is mechanically or electronically connected with the guides 16. The user can operate the foot pedal 20 to control rotation of the adjustable knobs 48, and thus control the corresponding movement of the positioning plates 50. In another example embodiment, a user can input information via the touchscreen 18 to electronically control the position of the positioning plates 50.

Referring back to FIG. 2, the touchscreen 18 is configured to receive inputs from a user (i.e., a finer tap, a stylus, and so forth) and displaying information thereon. To do so, the printer 10 includes a database 52 configured to store information to be printed on the clothing tag 12. The information to be printed on the clothing tag 12 is retrieved from the database 50 by an electronic processor 54 responsive to the at least one user input. The information to be printed on the clothing tag 12 stored in the database 52 includes one or more of price (including converting currencies), text, one or more symbols, one or more barcodes, one or more logos, and languages(including translations). The electronic processor 54 can then control the touchscreen 18 to display fields related to each of these types of information, allowing the user to make selections for the information to be printed on the clothing tag 12. In another example, the touchscreen 18 can include a camera or scanner (not shown) that can scan a barcode on any suitable clothing tag, and generate a template for the scanned tag of the clothing item (i.e., a 40 regular men's suit), and store the template in the database 52.

Once the user inputs the necessary information to the touchscreen 18, the ink ribbon 30 is controlled to print the input information onto the clothing tag 12 when the clothing tag 12 is positioned between the guides 16. In some embodiments, the electronic processor 54 or the touchscreen 18 can receive these inputs and control operation of the ink ribbon 30. In another embodiment, the foot pedal 20 can be operated by the user to control operation of the ink ribbon 30.

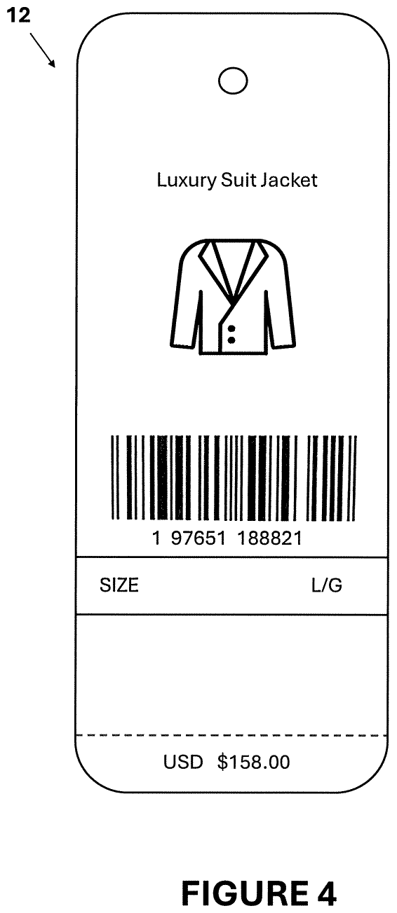

FIG. 4 shows an example of the printed clothing tag 12. As shown in FIG. 4, the clothing tag 12 includes a description of goods (“luxury suit jacket”, a picture of the goods, a bar code, a size of the goods, and a price of the goods. It will be appreciated that the printed clothing tag 12 can include other information, including but not limited to price, text, one or more symbols, one or more barcodes, one or more logos, and languages.

While the embodiments of the disclosure have been disclosed herein, certain modifications may be made by those skilled in the art to modify the invention without departing from the spirit of the invention.

What is claimed is:

1. A printer (10) for printing an associated clothing tag (12), the printer comprising:
a printer main body (14); and
at least one guide (16) disposed on the printer main body, the at least one guide configured to position the associated clothing tag on a portion of the printer main body.

2. The printer (10) of claim 1, wherein the at least one guide (16) comprises:
an adjustable knob (48); and
a positioning plate (50) attached to the adjustable knob and the printer main body (14).

3. The printer (10) of claim 2, wherein, upon rotation of the adjustable knob (48), the positioning plate (50) is configured to move laterally along a portion of the printer main body (14).

4. The printer (10) of claim 1, wherein the at least one guide (16) comprises two guides, each guide including:
an adjustable knob (48); and
a positioning plate (50) attached to the adjustable knob and the printer main body (14).

5. The printer (10) of claim 4, wherein, upon rotation of at least one of the adjustable knobs (48), the corresponding positioning plate (50) is configured to move laterally along a portion of the printer main body (14).

6. The printer (10) of claim 5, wherein the positioning plates (50) are configured to move laterally along the portion of the printer main body (14) until the positioning plates define a space to position the associated clothing tag (12) therebetween.

7. The printer (10) of claim 1, further comprising:
an ink ribbon (30);
a touchscreen (18) attached to a portion of the printer main body (14); wherein the touchscreen is configured to:
receive at least one user input indicative of information to be printed on the associated clothing tag (12); and
control the ink ribbon to print the information to be printed on the clothing tag onto the clothing tag.

8. The printer (10) of claim 7, further comprising:
a database (52) configured to store information to be printed on the associated clothing tag (12), wherein the information to be printed on the clothing tag is retrieved from the database responsive to the at least one user input.

9. The printer (10) of claim 8, wherein the information to be printed on the clothing tag stored in the database (52) includes one or more of price, text, one or more symbols, one or more barcodes, one or more logos, and languages.

10. The printer (10) of claim 7, further comprising:
a pedal (20) operable by a user to control operation of the ink ribbon (30) to print the information to be printed on the associated clothing tag (12) onto the associated clothing tag.

11. A printer (10) for printing an associated clothing tag (12), the printer comprising:
a printer main body (14); and
two guides (16) disposed on the printer main body, the guides configured to position the associated clothing tag on a portion of the printer main body.

12. The printer (10) of claim 11, wherein each guide (16) comprises:
an adjustable knob (48); and
a positioning plate (50) attached to the adjustable knob and the printer main body (14).

13. The printer (10) of claim 12, wherein, upon rotation of at least one of the adjustable knobs (48), the corresponding positioning plate (50) is configured to move laterally along a portion of the printer main body (14 until the positioning plates define a space to position the associated clothing tag (12) therebetween).

14. The printer (10) of claim 11, further comprising:
an ink ribbon (30);
a touchscreen (18) attached to a portion of the printer main body (14); wherein the touchscreen is configured to:
receive at least one user input indicative of information to be printed on the associated clothing tag (12); and
control the ink ribbon to print the information to be printed on the clothing tag onto the clothing tag.

15. The printer (10) of claim 7, further comprising:
a database (52) configured to store information to be printed on the associated clothing tag (12), wherein the information to be printed on the clothing tag is retrieved from the database responsive to the at least one user input.

16. A printer (10) for printing an associated clothing tag (12), the printer comprising:
a printer main body (14);
an ink ribbon (30);
at least one guide (16) disposed on the printer main body, the at least one guide configured to position the associated clothing tag on a portion of the printer main body; and
a touchscreen (18) attached to a portion of the printer main body (14); wherein the touchscreen is configured to:
receive at least one user input indicative of information to be printed on the associated clothing tag; and
control the ink ribbon to print the information to be printed on the clothing tag onto the clothing tag.

17. The printer (10) of claim 16, wherein the at least one guide (16) comprises:
an adjustable knob (48); and
a positioning plate (50) attached to the adjustable knob and the printer main body (14).

18. The printer (10) of claim 17, wherein, upon rotation of the adjustable knob (48), the positioning plate (50) is configured to move laterally along a portion of the printer main body (14).

19. The printer (10) of claim 16, wherein the at least one guide (16) comprises two guides, each guide including:
an adjustable knob (48); and
a positioning plate (50) attached to the adjustable knob and the printer main body (14).

20. The printer (10) of claim 19, wherein, upon rotation of at least one of the adjustable knobs (48), the corresponding positioning plate (50) is configured to move laterally along a portion of the printer main body (14) until the positioning plates define a space to position the associated clothing tag (12) therebetween.
